(19) United States
(12) Patent Application Publication
(10) Pub. No.: US 2025/0188241 A1
(43) Pub. Date: Jun. 12, 2025

(54) RETICULATED POLYURETHANE MATERIAL AND PREPARATION METHOD AND APPLICATION THEREOF

(71) Applicant: Dongguan Sinohome Ltd., Dongguan (CN)

(72) Inventor: CHIFAN LAM, Dongguan (CN)

(73) Assignee: Dongguan Sinohome Ltd., Dongguan (CN)

(21) Appl. No.: 18/639,590

(22) Filed: Apr. 18, 2024

(30) Foreign Application Priority Data
Dec. 8, 2023 (CN) 202311691059.5

(51) Int. Cl. C08J 9/42; C08G 18/16; C08G 18/24; C08G 101/00; C08J 9/00; C08J 9/14

(52) U.S. Cl. CPC C08J 9/42; C08G 18/168; C08G 18/242; C08J 9/0009; C08J 9/141; C08J 9/145; C08G 2101/00; C08J 2375/04; C08J 2483/04

(57) ABSTRACT

The present invention relates to the technical field of processing of polymer material, and in particular, to a reticulated polyurethane material and a preparation method and application thereof, including a foam material layer and a composite glue layer applied on one side of the foam material layer, where a plurality of mesh holes are formed in the foam material layer that penetrate an upper surface and a lower surface of the foam material layer, the mesh holes are uniformly distributed in the foam material layer, the composite glue layer is formed by applying a composite liquid glue, and the composite liquid glue on a side of the composite glue layer close to the foam material layer permeates into foam holes of the foam material. The reticulated polyurethane material in the present invention solves problems in the prior art.

### CROSS-REFERENCE TO RELATED APPLICATIONS

The application claims priority to Chinese patent application No. 202311691059.5, filed on Dec. 8, 2023, the entire contents of which are incorporated herein by reference.

### TECHNICAL FIELD

The present invention relates to the technical field of processing of polymer material, and in particular, to a reticulated polyurethane material and a preparation method and application thereof.

### BACKGROUND

In recent years, with the gradual improvement of living standards, people are placing greater emphasis on the quality of life, demanding enhanced performance in daily sponge products such as pillows, back cushions, seat cushions, and mattresses. Specifically, they seek improvement in comfort, air permeability, and service life, etc. A conventional polyurethane material after use for a long time tends to lose its elasticity, decline in hardness, and even form a recess locally, thereby destroying the original comfort of the product, shortening the service life, and seriously affecting the use effect.

The polyurethane-based daily products currently available on the market generally only meet the requirement for appropriate hardness, but they tend to be simplistic in terms of both process and structure. Therefore, they are difficult to meet the requirements for modernization, humanization and individualization. Polyurethane-based household supplies, poor in air permeability and moisture dissipation, are prone to mildew or breed bacteria and other microorganisms over time, which is not conducive to human health.

### SUMMARY

To overcome the disadvantages and deficiencies in the prior art, the present invention aims to provide a reticulated polyurethane material. The reticulated polyurethane material in the present invention solves the problems in the prior art. The reticulated polyurethane material offers good air permeability, appropriate hardness and long-term resistance to deformation, ensuring a stable and comfortable experience. It combines aesthetic appearance and excellent air permeability.

Another object of the present invention is to provide a method for preparing a reticulated polyurethane material. The method is simple in operation, easy to control, high in production efficiency, and low in production costs.

Yet another object of the present invention is to provide an application of a reticulated polyurethane material. Based on original performance, the reticulated polyurethane material is improved in supporting force and ductility, providing better dispersed support for a human body, stress relief, durability, comfort, and stability. It can be applied to household supplies such as pillows, back cushions and mattresses.

An object of the present invention is achieved by the following technical solutions: a reticulated polyurethane material, including a foam material layer and a composite glue layer applied on one side of the foam material layer, where a plurality of mesh holes are formed in the foam material layer that penetrate an upper surface and a lower surface of the foam material layer, the mesh holes are uniformly distributed in the foam material layer, the composite glue layer is formed by applying a composite liquid glue, and the composite liquid glue on a side of the composite glue layer close to the foam material layer permeates into foam holes of the foam material.

In the present invention, compared with a conventional foam material, the reticulated polyurethane material that adopts the foregoing structure uses less polyurethane flexible foam per unit area due to its unique structure, therefore the production cost is greatly reduced; it offers significantly improved comfort, more stable experience, long-term resistance to deformation, and better dispersed support for a human body; and it combines aesthetic appearance and excellent air permeability.

Preferably, a shape of the mesh hole is one of diamond, rectangle, circle, oval, or triangle; and the foam material layer is a polyurethane flexible foam layer.

Preferably, the composite liquid glue includes the following raw materials in parts by weight: 20-70 parts of a liquid glue, 0.1-0.3 parts of a catalyst, and 1-5 parts of a foaming agent.

Preferably, the liquid glue is one of liquid silicone rubber and polyurethane glue.

Preferably, the catalyst is one or both of organic tin and organic amine.

Preferably, the foaming agent is one or more of dichloromethane, dichloroethane, and pentane.

The foregoing composite liquid glue used in the present invention has characteristics of good fluidity, rapid curing speed, high transparency after curing, and being safe and environmentally friendly. The composite liquid glue has excellent tear resistance, resilience, yellowing resistance, thermal stability, and heat and aging resistance.

The present invention further provides a method for preparing a reticulated polyurethane material, including the following steps:
S1: a liquid glue, a catalyst and a foaming agent are put into a stirring kettle in parts by weight and mixed uniformly to obtain a composite liquid glue for subsequent use;
S2: a sheet-shaped foam material meeting requirements is selected based on demand for subsequent use;
S3: a cutter die of a corresponding shape is selected and fixed onto a stamping equipment, the foam material placed on the stamping equipment is stamped, cutting is performed to form uniformly distributed cutting lines, and thus a foam material layer is obtained for subsequent use;
S4: the foam material layer processed in step S3 is rolled by rollers to enable the composite liquid glue to uniformly permeate into foam holes of the foam material so as to form a composite glue layer for subsequent use; and
S5: the glue-applied foam material is stretched by an external force so as to make the cutting lines open to form mesh holes, and then the composite glue layer is heated and photo-cured to form the reticulated polyurethane material.

The reticulated polyurethane material in the present invention is prepared by using the foregoing method. This process is simple in operation, easy to control, high in production efficiency, and low in production costs.

Preferably, in step 5, a curing temperature is 78-84° C., and a curing time is 10-20 min.

Preferably, in step 3, a length of the cutting line is 10-40 mm, a longitudinal spacing between the cutting lines is 2-12 mm, and a transverse spacing between the cutting lines is 2-12 mm.

The present invention further provides an application of a reticulated polyurethane material, and the reticulated polyurethane material is applied to the manufacture of sponge products such as pillows, back cushions, seat cushions or mattresses.

The beneficial effects of the present invention are as follows:
1. the reticulated polyurethane material in the present invention solves problems in the prior art; the reticulated polyurethane material offers good air permeability, appropriate hardness and long-term resistance to deformation, ensuring a stable and comfortable experience; and it combines aesthetic appearance and excellent air permeability;
2. the method for preparing the reticulated polyurethane material is simple in operation, easy to control, high in production efficiency, and low in production costs; and
3. based on original performance, the reticulated polyurethane material is improved in supporting force and ductility, providing better dispersed support for a human body, stress relief, durability, comfort, and stability; and it can be applied to household supplies such as pillows, back cushions and mattresses.

### BRIEF DESCRIPTION OF DRAWINGS

FIG. 1 is a schematic diagram of a pattern cut in Example 1 of the present invention;

FIG. 2 is a schematic diagram of a pattern cut in Example 2 of the present invention; and

FIG. 3 is a schematic diagram of a pattern cut in Example 3 of the present invention.

### DETAILED DESCRIPTION OF THE EMBODIMENTS

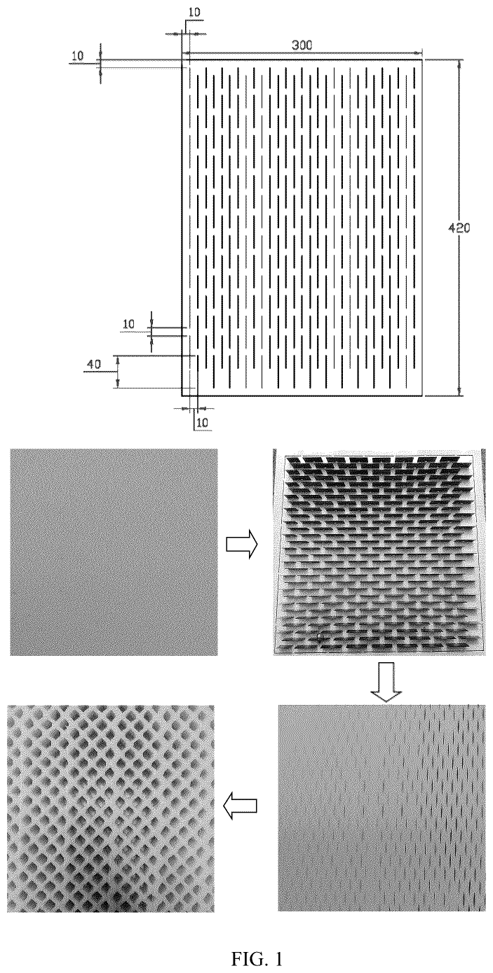

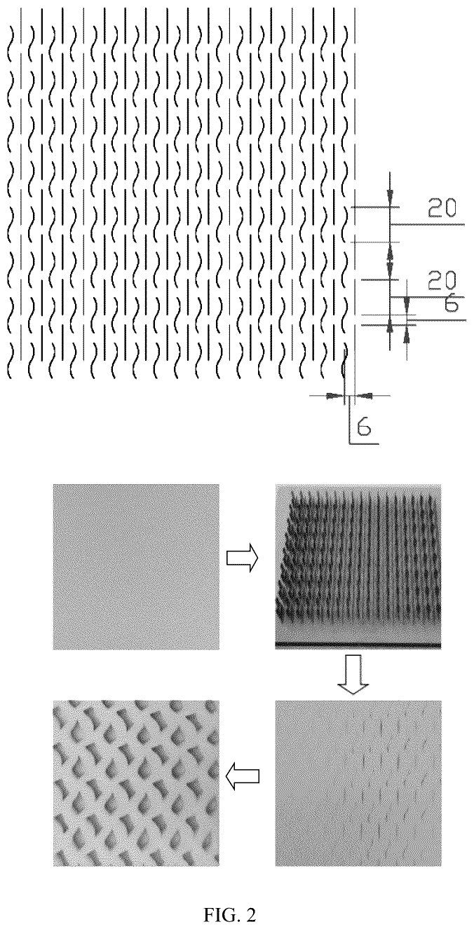

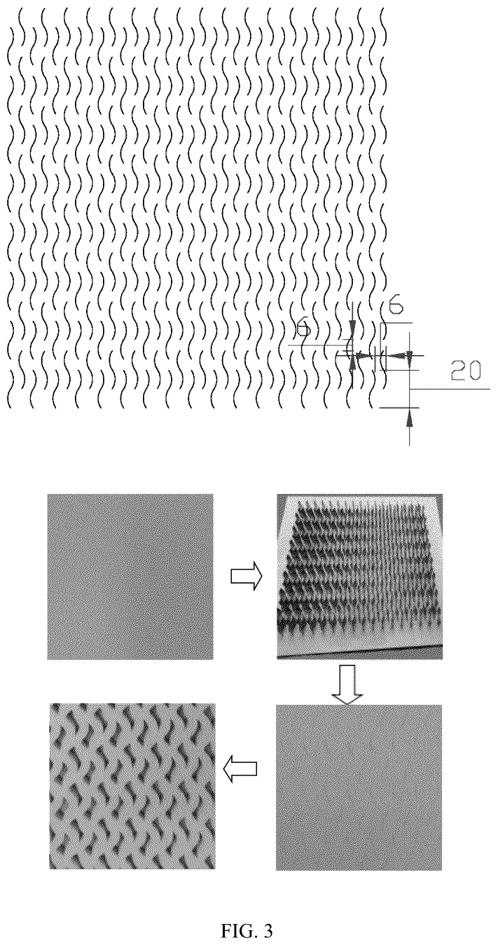

To facilitate understanding of people skilled in the art, the present invention is further described below with reference to examples and FIGS. 1 to 3, and contents mentioned in implementations are not intended to limit the present invention.

### Example 1

A reticulated polyurethane material, including a foam material layer and a composite glue layer applied on one side of the foam material layer, where a plurality of mesh holes are formed in the foam material layer that penetrate an upper surface and a lower surface of the foam material layer, the mesh holes are uniformly distributed in the foam material layer, the composite glue layer is formed by applying a composite liquid glue, and the composite liquid glue on a side of the composite glue layer close to the foam material layer permeates into foam holes of the foam material.

The mesh hole is in a diamond shape, and the foam material layer is a polyurethane flexible foam layer.

The composite liquid glue includes the following raw materials in parts by weight: 20 parts of a liquid glue, 0.1 parts of a catalyst, and 1 part of a foaming agent.

The liquid glue is liquid silicone rubber, specifically the AB liquid silicone rubber with an article number of js-1125 supplied by Taian Junshuo Building Materials Co., Ltd.; the catalyst is organic tin, specifically the dibutyltin dilaurate T-12 catalyst supplied by Jinan Haiyuan Chemical Co., Ltd.; and the foaming agent is dichloromethane.

The reticulated polyurethane material is prepared by the following steps:
S1: a liquid glue, a catalyst and a foaming agent are put into a stirring kettle in parts by weight and mixed uniformly to obtain a composite liquid glue for subsequent use;
S2: a sheet-shaped foam material meeting requirements is selected based on demand for subsequent use;
S3: a cutter die of a corresponding shape is selected and fixed onto a stamping equipment, the foam material placed on the stamping equipment is stamped, cutting is performed to form uniformly distributed cutting lines, and thus a foam material layer is obtained for subsequent use;
S4: the foam material layer processed in step S3 is rolled by rollers to enable the composite liquid glue to uniformly permeate into foam holes of the foam material so as to form a composite glue layer for subsequent use; and
S5: the glue-applied foam material is stretched by an external force so as to make the cutting lines open to form mesh holes, and then the composite glue layer is heated and photo-cured to form the reticulated polyurethane material.

In step S3, a cutting element used during cutting is composed of a wooden board and a cutting device with cutter edges above the wooden board. The configured cutter edges are 1.5 cm away from the wooden board, and used for providing discontinuous rectilinear slits along lines extending longitudinally of the foam material layer to form uniformly distributed holes by cutting, where the holes are diamond-shaped.

In step 5, a curing temperature is 78° C., and a curing time is 20 min.

In step 3, a length of the cutting line is 10 mm, a longitudinal spacing between the cutting lines is 2 mm, and a transverse spacing between the cutting lines is 2 mm.

The reticulated polyurethane material is applied to the manufacture of sponge products such as pillows, back cushions, seat cushions or mattresses.

### Example 2

A reticulated polyurethane material, including a foam material layer and a composite glue layer applied on one side of the foam material layer, where a plurality of mesh holes are formed in the foam material layer that penetrate an upper surface and a lower surface of the foam material layer, the mesh holes are uniformly distributed in the foam material layer, the composite glue layer is formed by applying a composite liquid glue, and the composite liquid glue on a side of the composite glue layer close to the foam material layer permeates into foam holes of the foam material.

The mesh hole is in a diamond shape, and the foam material layer is a polyurethane flexible foam layer.

The composite liquid glue includes the following raw materials in parts by weight: 40 parts of a liquid glue, 0.2 parts of a catalyst, and 3 part of a foaming agent.

The liquid glue is liquid silicone rubber, specifically the AB liquid silicone rubber with an article number of js-1125 supplied by Taian Junshuo Building Materials Co., Ltd.; the catalyst is organic tin, specifically the dibutyltin dilaurate T-12 catalyst supplied by Jinan Haiyuan Chemical Co., Ltd.; and the foaming agent is dichloromethane.

The reticulated polyurethane material is prepared by the following steps:
S1: a liquid glue, a catalyst and a foaming agent are put into a stirring kettle in parts by weight and mixed uniformly to obtain a composite liquid glue for subsequent use;
S2: a sheet-shaped foam material meeting requirements is selected based on demand for subsequent use;
S3: a cutter die of a corresponding shape is selected and fixed onto a stamping equipment, the foam material placed on the stamping equipment is stamped, cutting is performed to form uniformly distributed cutting lines, and thus a foam material layer is obtained for subsequent use;
S4: the foam material layer processed in step S3 is rolled by rollers to enable the composite liquid glue to uniformly permeate into foam holes of the foam material so as to form a composite glue layer for subsequent use; and
S5: the glue-applied foam material is stretched by an external force so as to make the cutting lines open to form mesh holes, and then the composite glue layer is heated and photo-cured to form the reticulated polyurethane material.

In step S3, a cutting element used during cutting is composed of a wooden board and a cutting device with cutter edges above the wooden board. The configured cutter edges are 1.5 cm away from the wooden board, and used for providing discontinuous rectilinear slits along lines extending longitudinally of the foam material layer, and slits are distributed between the rectilinear slits, where the cut holes are diamond-shaped.

In step 5, a curing temperature is 80° C., and a curing time is 15 min.

In step 3, a length of the cutting line is 25 mm, a longitudinal spacing between the cutting lines is 7 mm, and a transverse spacing between the cutting lines is 7 mm.

The reticulated polyurethane material is applied to the manufacture of sponge products such as pillows, back cushions, seat cushions or mattresses.

### Example 3

A reticulated polyurethane material, including a foam material layer and a composite glue layer applied on one side of the foam material layer, where a plurality of mesh holes are formed in the foam material layer that penetrate an upper surface and a lower surface of the foam material layer, the mesh holes are uniformly distributed in the foam material layer, the composite glue layer is formed by applying a composite liquid glue, and the composite liquid glue on a side of the composite glue layer close to the foam material layer permeates into foam holes of the foam material.

The mesh hole is in a diamond shape, and the foam material layer is a polyurethane flexible foam layer.

The composite liquid glue includes the following raw materials in parts by weight: 70 parts of a liquid glue, 0.3 parts of a catalyst, and 5 part of a foaming agent.

The liquid glue is liquid silicone rubber, specifically the AB liquid silicone rubber with an article number of js-1125 supplied by Taian Junshuo Building Materials Co., Ltd.; the catalyst is organic tin, specifically the dibutyltin dilaurate T-12 catalyst supplied by Jinan Haiyuan Chemical Co., Ltd.; and the foaming agent is pentane.

The reticulated polyurethane material is prepared by the following steps:
S1: a liquid glue, a catalyst and a foaming agent are put into a stirring kettle in parts by weight and mixed uniformly to obtain a composite liquid glue for subsequent use;
S2: a sheet-shaped foam material meeting requirements is selected based on demand for subsequent use;
S3: a cutter die of a corresponding shape is selected and fixed onto a stamping equipment, the foam material placed on the stamping equipment is stamped, cutting is performed to form uniformly distributed cutting lines, and thus a foam material layer is obtained for subsequent use;
S4: the foam material layer processed in step S3 is rolled by rollers to enable the composite liquid glue to uniformly permeate into foam holes of the foam material so as to form a composite glue layer for subsequent use; and
S5: the glue-applied foam material is stretched by an external force so as to make the cutting lines open to form mesh holes, and then the composite glue layer is heated and photo-cured to form the reticulated polyurethane material.

In step S3, a cutting element used during cutting is composed of a wooden board and a cutting device with cutter edges above the wooden board. The configured cutter edges are 1.5 cm away from the wooden board, and used for providing discontinuous slits along lines extending longitudinally of the sponge foam layer to form complete diamond-shaped holes by cutting.

The cutting element is composed of a wooden board and a cutting device with some specially designed cutter edges above the wooden board. The configured cutter edges are 1.5 cm away from the wooden board, and used for providing discontinuous slits along lines extending longitudinally of the sponge foam layer to form complete diamond-shaped holes by cutting.

In step 5, a curing temperature is 84° C., and a curing time is 10 min.

In step 3, a length of the cutting line is 40 mm, a longitudinal spacing between the cutting lines is 12 mm, and a transverse spacing between the cutting lines is 12 mm.

The reticulated polyurethane material is applied to the manufacture of sponge products such as pillows, back cushions, seat cushions or mattresses.

A performance test is performed on the reticulated polyurethane materials prepared in Examples 1-3, and test results are as stated in table 1:

TABLE 1

| | Air Permeability | 40% Indentation | Tear Strength |
|---|---|---|---|
| | (ft 3/min) | Hardness (N) | (N/CM) |
| conventional | 2.5 | 60 | 0.82 |
| polyurethane | | | |
| materia | | | |
| Example 1 | 4.8 | 65 | 0.98 |
| Example 2 | 4.8 | 71 | 1.26 |
| Example 3 | 4.8 | 80 | 1.53 |

It can be seen from the foregoing test data that the reticulated polyurethane material of the present invention offers good air permeability, appropriate hardness and long-term resistance to deformation, ensuring a stable and comfortable experience, and it combines aesthetic appearance and excellent air permeability.

The foregoing embodiments are preferred implementations of the present invention. In addition, the present invention may be implemented in another manner, and any obvious replacement without departing from the concept of the present invention shall belong to the scope of protection of the present invention.

What is claimed is:

1. A reticulated polyurethane material, including a foam material layer and a composite glue layer applied on one side of the foam material layer, wherein a plurality of mesh holes are formed in the foam material layer that penetrate an upper surface and a lower surface of the foam material layer, the mesh holes are uniformly distributed in the foam material layer, the composite glue layer is formed by applying a composite liquid glue, and the composite liquid glue on a side of the composite glue layer close to the foam material layer permeates into foam holes of the foam material.

2. The reticulated polyurethane material according to claim 1, wherein a shape of the mesh hole is one of diamond, rectangle, circle, oval, or triangle; and the foam material layer is a polyurethane flexible foam layer.

3. The reticulated polyurethane material according to claim 1, wherein the composite liquid glue comprises the following raw materials in parts by weight: 20-70 parts of a liquid glue, 0.1-0.3 parts of a catalyst, and 1-5 parts of a foaming agent.

4. The reticulated polyurethane material according to claim 3, wherein the liquid glue is one of liquid silicone rubber and polyurethane glue.

5. The reticulated polyurethane material according to claim 3, wherein the catalyst is one or both of organic tin and organic amine.

6. The reticulated polyurethane material according to claim 1, wherein the foaming agent is one or more of dichloromethane, dichloroethane, and pentane.

7. A method for preparing the reticulated polyurethane material according to claim 3, comprising the following steps:
S1: a liquid glue, a catalyst and a foaming agent are put into a stirring kettle in parts by weight and mixed uniformly to obtain a composite liquid glue for subsequent use;
S2: a sheet-shaped foam material meeting requirements is selected based on demand for subsequent use;
S3: a cutter die of a corresponding shape is selected and fixed onto a stamping equipment, the foam material placed on the stamping equipment is stamped, cutting is performed to form uniformly distributed cutting lines, and thus a foam material layer is obtained for subsequent use;
S4: the foam material layer processed in step S3 is rolled by rollers to enable the composite liquid glue to uniformly permeate into foam holes of the foam material so as to form a composite glue layer for subsequent use; and
S5: the glue-applied foam material is stretched by an external force so as to make the cutting lines open to form mesh holes, and then the composite glue layer is heated and photo-cured to form the reticulated polyurethane material.

8. The reticulated polyurethane material according to claim 7, wherein in step 5, a curing temperature is 78-84° C., and a curing time is 10-20 min.

9. The reticulated polyurethane material according to claim 7, wherein in step 3, a length of the cutting line is 10-40 mm, a longitudinal spacing between the cutting lines is 2-12 mm, and a transverse spacing between the cutting lines is 2-12 mm.

10. An application of the reticulated polyurethane material according to claim 1, wherein the reticulated polyurethane material is applied to the manufacture of sponge products such as pillows, back cushions, seat cushions or mattresses.
